(19) United States
(12) Patent Application Publication
(10) Pub. No.: US 2016/0251472 A1
(43) Pub. Date: Sep. 1, 2016

(54) POLYFUNCTIONAL URETHANE (METH)ACRYLATES COMPRISING LOW-MONOMER-CONTENT DIISOCYANATE MONOADDUCTS

(71) Applicants: Emmanouil SPYROU, Schermbeck (DE); Holger LOESCH, Herne (DE); Marion EWALD, Marl (DE); Laura RAMON-GIMENEZ, Essen (DE); Andrea THESING, Ahaus (DE)

(72) Inventors: Emmanouil SPYROU, Schermbeck (DE); Holger LOESCH, Herne (DE); Marion EWALD, Marl (DE); Laura RAMON-GIMENEZ, Essen (DE); Andrea THESING, Ahaus (DE)

(73) Assignee: EVONIK DEGUSSA GMBH, Essen (DE)

(21) Appl. No.: 15/027,915

(22) PCT Filed: Sep. 30, 2014
(86) PCT No.: PCT/EP2014/070853

§ 371 Date: Apr. 7, 2016

(30) Foreign Application Priority Data
Oct. 8, 2013 (DE) 10 2013 220 239.3

(51) Int. Cl. C08G 18/75; C09J 175/04; C08G 18/24; C09D 175/04; C08G 18/67; C08G 18/32

(52) U.S. Cl. CPC C08G 18/755; C08G 18/672; C08G 18/3206; C08G 18/246; C09D 175/04; C09J 175/04

(57) ABSTRACT

Polyfunctional urethane (meth)acrylates comprising low-monomer-content diisocyanate monoadducts

The invention relates to polyfunctional urethane (meth)acrylates comprising low-monomer-content diisocyanate monoadducts.

Urethane (meth)acrylates occupy an important position within radically polymerizable resins. They consist in general of hydroxyl-containing resins, diisocyanates and compounds which contain both an alcohol group and an activated double bond, e.g. hydroxyethyl acrylate (HEA). Such urethane (meth)acrylates (a collective designation both for urethane acrylates and for urethane methacrylates) are distinguished in the fully cured coating by an outstanding balance between hardness and flexibility.

A substantial disadvantage of such urethane acrylates lies in their high viscosity, especially if they are based on alcohols of relatively high functionality (functionality≧3). The high viscosity makes application more difficult in radically polymerizable coating systems, adhesives systems and sealant systems.

It was an object of the present invention to find relatively high-functional urethane (meth)acrylates having a viscosity lower by at least 30% than that of conventional products. Important here are not only the inherent viscosity, of the substance itself, but also the viscosity in solution.

The object has been achieved through the use of low-monomer-content adducts of diisocyanates and compounds containing both an alcohol group and an activated double bond in the preparation of urethane (meth)acrylate.

The properties of coating, adhesives and sealant systems are highly dependent in general on the resins used. Depending on the field of use, these resins may have different chemical compositions, and also different characteristic physical data, examples being their glass transition points, Tg. These Tgs may range from temperatures well below 0° C. to well above 100° C. (e.g. for powder coating applications). When an attempt is made to modify a hydroxy-functional resin of this kind to make it a radiation-curable resin, by reaction with diisocyanates and HEA, for example, the viscosity of the end product is dependent primarily on the Tg of the starting resin. When, however, an attempt is made, based on a particular OH resin, to obtain a very low viscosity, the process of the invention affords significant advantages over the prior art.

Surprisingly it has emerged that in the reaction of low-monomer-content adducts with hydroxyl-containing resins, a reduced viscosity occurs particularly when the OH functionality of these resins is at least 3 or higher.

The invention provides urethane (meth)acrylates comprising the reaction product of
A) low-monomer-content 1:1 monoadducts of
   a1) diisocyanates and
   a2) compounds which contain both an alcohol group and an activated double bond,
   having a free diisocyanate content of less than 5 wt %, with
B) at least one resin component having at least three OH groups per molecule;
where for each OH group in component B) there are 0.2 to 1.1 NCO equivalents of component A).

Low-monomer-content adducts A) of diisocyanates and compounds containing both an alcohol group and an activated double bond have already been described in EP 2 367 864 and also in EP 1 179 555. They are prepared in general by reacting an excess of diisocyanate with a compound containing both an alcohol group and an activated double bond, hydroxyethyl acrylate for example, completely at temperatures between 40-80° C. Thereafter the excess diisocyanate is removed by distillation, generally in a thin-film evaporator or short-path evaporator. Frequently for this purpose it is necessary to use specific inhibitors and also to observe particular distillation conditions, so that the residue does not polymerize.

Suitable isocyanates a1) are aliphatic, cycloaliphatic and araliphatic, i.e. aryl-substituted aliphatic diisocyanates, of the kind described, for example, in Houben-Weyl, Methoden der organischen Chemie, Volume 14/2, pages 61-70 and in the article by W. Siefken, Justus Liebigs Annalen der Chemie 562, 75-136, such as, for example, 1,2-ethylene diisocyanate, 1,4-tetramethylene diisocyanate, 1,6-hexamethylene diisocyanate (HDI), 2,2,4-trimethyl-1,6-hexamethylene diisocyanate (TMDI), 2,4,4-trimethyl-1,6-hexamethylene diisocyanate (TMDI), 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3-diisocyanate, cyclohexane 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethylcyclohexane, decahydro-8-methyl-(1,4-methanonaphthalen-2,5-ylenedimethylene diisocyanate, decahydro-8-methyl-(1,4-methanonaphthalen-3,5-ylenedimethylene diisocyanate, hexahydro-4,7-methanoindan-1,5-ylenedimethylene diisocyanate, hexahydro-4,7-methanoindan-2,5-ylenedimethylene diisocyanate, hexahydro-4,7-methanoindan-1,6- ylenedimethylene diisocyanate, hexahydro-4,7-methanoindan-2,5-ylenedimethylene diisocyanate, hexahydro-4,7-methanoindan-1,5-ylene diisocyanate, hexahydro-4,7-methanoindan-2,5-ylene diisocyanate, hexahydro-4,7-methanoindan-1,6-ylene diisocyanate, hexahydro-4,7-methanoindan-2,6-ylene diisocyanate, 2,4-hexahydrotolylene diisocyanate, 2,6-hexahydrotolylene diisocyanate, 4,4′-methylenedicyclohexyl diisocyanate (4,4′-H₁₂MDI), 2,2′-methylenedicyclohexyl diisocyanate (2,2′-H₁₂MDI), 2,4-methylenedicyclohexyl diisocyanate (2,4-H₁₂MDI) or else mixtures of these isomers, 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, and also any desired mixtures of these compounds. Other suitable isocyanates are described in the stated article in the Annalen on page 122 f. Also suitable are 2,5-bis(isocyanatomethyl)bicyclo[2.2.1]heptane (NBDI) and/or 2,6-bis(isocyanatomethyl(bicyclo[2.2.1]heptane (NBDI), as the pure substance or as a mixed component. These diisocyanates are nowadays prepared generally either by the phosgene route or by the urea process. The products of both methods are equally suitable for use in the process of the invention.

The diisocyanates listed may be used alone or in any desired mixtures.

Particular preference is given to using aliphatic and cycloaliphatic diisocyanates selected from IPDI, HDI, TMDI, and H₁₂MDI (pure H₁₂MDI isomers or their isomer mixtures), alone or in any desired mixtures.

Suitable in principle as compounds a2), containing both an alcohol group and an activated double bond, are all compounds of this kind.

Suitable preferred reactive olefinic compounds a2) are all compounds which both carry at least one methacrylate or acrylate functional or vinyl ether group, and also precisely one hydroxyl group. Further constituents may be aliphatic, cycloaliphatic, aromatic or heterocyclic alkyl groups. Oligomers or polymers are conceivable as well.

Preference is given to using hydroxyethyl acrylate, hydroxypropyl acrylate, hydroxybutyl acrylate and hydroxyethyl methacrylate, hydroxypropyl methacrylate, hydroxybutyl methacrylate, glycerol diacrylate, pentaerythritol triacrylate, trimethylolpropane diacrylate, glycerol dimethacrylate, pentaerythritol trimethacrylate and trimethylolpropane dimethacrylate, hydroxyethyl vinyl ether, hydroxypropyl vinyl ether, hydroxybutyl vinyl ether, hydroxypentyl vinyl ether and/or hydroxyhexyl vinyl ether. Mixtures as well can of course be used. Particular preference is given to using hydroxyethyl acrylate.

The reaction of polyisocyanates with reactive olefinic compounds comprises the reaction of the free NCO groups with hydroxyl groups and has already been frequently desscribed (EP 0 669 353, EP 0 669 354, DE 30 30 572, EP 0 639 598 or EP 0 803 524). This reaction may take place either with or else without solvent. It is generally conducted in a temperature range between 40 and 80° C. and can be catalysed advantageously by common catalysts known within urethane chemistry, such as, for example, organometallic compounds, such as dibutyltin dilaurate (DBTL), dibutyltin dineodecanoate, zinc octoate or bismuth neodecanoate, for example, or else tertiary amines, such as triethylamine or diazabicyclooctane, for example. Suitable reaction assemblies include all customary apparatus, tanks, static mixers, extruders, etc., preferably assemblies which possess a mixing or stirring function. The NCO/OH ratio is 2:1 to 40:1, preferably 2:1 to 9.8:1 and more preferably 3: 1 to 8: 1. This corresponds to a reaction of 1-20 mol, preferably 1-4.9 mol, more preferably 1.5-4 mol of diisocyanate A) with 1 mol of a reactive olefinic compound a2).

The low-monomer-content 1:1 monoadducts A) of the invention, comprising al) diisocyanates and a2) compounds containing both an alcohol group and an activated double bond, have a free diisocyanate content of less than 5 wt %, preferaby less than 1 wt % and more preferably less than 0.5 wt %. The monoadducts preferably have a free NCO content of 10.4-16.4 wt %.

Contemplated as a resin component having at least three OH groups per molecule, B) (polyols) are polyesters, polycaprolactones, polyethers, poly (meth)acrylates, polycarbonates and polyurethanes, and also monomeric polyols, having an OH functionality ≧3 and an OH number of 5 to 2000 mg KOH/gram and an average molar mass of 92 to 30 000 g/mol. Preference is given to polyols having an OH number of 30 to 200 mg KOH/gram and an average molar mass of 840 to 5600 g/mol. Preferred polyols are, in particular, polyesters and/or polyethers.

It will be appreciated that mixtures of such resin components B) can also be used.

The amount of the resin component B) containing OH groups is selected such that for each OH group in component B) there are 0.2 to 1.1 NCO equivalents of the component A).

The invention also provides a process for preparing urethane (meth)acrylates obtainable by reaction of
A) low-monomer-content 1 : 1 monoadducts of
   a1) diisocyanates and
   a2) compounds which contain both an alcohol group and an activated double bond,
having a free diisocyanate content of less than 5 wt %, with
B) at least one resin component having at least three OH groups per molecule;
   for each OH group in component B) there are 0.2 to 1.1 NCO equivalents of component A).

The reaction of component A) with component B) comprises the reaction of the free NCO groups with hydroxyl groups, and has already been frequently described (EP 0 669 353, EP 0 669 354, DE 30 30 572, EP 0 639 598 or EP 0 803 524). This reaction can take place either with solvent, or else, preferably, without solvent. It is carried out in general in a temperature range between 40 and 80° C. and can be catalysed advantageously by common catalysts known in urethane chemistry, such as organometallic compounds, for example, such as dibutyltin dilaurate (DBTL), dibutyltin dineodecanoate, zinc octoate or bismuth neodecanoate, for example, or else by tertiary amines, such as triethylamine or diazabicyclooctane, etc., for example. Suitable reaction assemblies include all customary apparatus, tanks, static mixers, extruders, etc., preferably assemblies which possess a mixing or stirring function.

The viscosity in bulk is measured at a suitable temperature between RT and 100° C. in accordance with DIN EN ISO 3219. The viscosity in solution is measured in a suitable solvent, such as in a reactive diluent, for example, at 23° C. in accordance with DIN EN ISO 3219. Suitable reactive diluents include all common liquid components which carry at least one polymerizable group, examples being acrylates, methacrylates, vinyl ethers, etc. Examples of such reactive diluents are hexanediol diacrylate, isobornyl acrylate, hydroxypropyl methacrylate, dipropylene glycol diacrylate, tripropylene glycol diacrylate, trimethylolpropane formal monoacrylate, trim ethylenepropane triacrylate, tetrahydrofurfuryl acrylate, phenoxyethyl acrylate, lauryl acrylate, pentaerythritol tetraacrylate, and also urethanized reactive diluents such as Ebecryl 1039 (Cytec) etcetera. Producers of such products are for example Cytec, Sartomer, BASF, Rahn, Akzo etcetera. Suitable concentrations of the urethane (meth)acrylates of the invention in reactive diluents are between 5 and 95 wt %, more particularly 10 to 50 wt %.

The invention also provides for the use of the above-described urethane acrylates in all kinds of radiation-curing formulations.

The examples which follow are intended to elucidate the invention and the capacity for it to be carried out.

### EXAMPLES

| Input | |
|---|---|
| materials | Product description, manufacturer |
| IPDI | Isophorone diisocyanate, Evonik Industries AG, |
| HEA | Hydroxyethyl acrylate, Aldrich |
| DBTL | Dibutyltin dilaurate, urethanization catalyst, Aldrich |
| BHT | 4-Methyl-2,6-di-tert-butylphenol, unincorporable inhibitor, |
| | Ciba |
| DBHBA | 2,6-Di-tert-butyl-4-hydroxybenzyl alcohol, Aldrich, |
| | incorporable inhibitor |
| CAPA 4101 | Tetrafunctional polycaprolactone, OHN: 225 mg KOH/g, |
| | Perstorp |
| Oxyester | Difunctional polyester, OHN: 107 ± 10 mg KOH/g, Evonik |
| T1136 | Industries AG |
| HDDA | Hexanediol diacrylate, reactive diluent, Aldrich |

A) Preparation of Low-Monomer-Content 1:1 IPDI-HEA monoadducts A) According to EP2 367 864

An intensely stirred mixture of 555 g (2.5 mol) of IPDI and 0.05 g of DBTL with 2.2 g of DBHBA and 4.4 g of BHT is admixed dropwise with 116 g (1 mol) of hydroxyethyl acrylate, with dry air being passed over the solution. After the end of the addition, stirring is continued at 80° C. until conversion of the hydroxyethyl acrylate alcohol component is complete (approximately 2.5 hours). During this reaction time as well, dry air is passed over. The batch is subsequently saturated with dry air, and the unreacted diisocyanate is removed at 200 g/h by means of short-path distillation (KDL 4, UIC GmbH, Alzenau-Horstein) at 150° C. and 2 mbar, with a steady stream of dry air being passed in counter-current through the apparatus. The product has an NCO content of 12.0 wt % and a monomer content of 0.3 wt %.

### B1) Preparation of Inventive Urethane Acrylates Based on Tetrafunctional Alcohols

53.8 g of low-monomer-content IPDI-HEA from Experiment 1 are introduced with 0.2 g of BHT and 0.2 g of DBTL, and heated to 50° C. 38.4 g of CAPA 4101 are added dropwise over the course of 1 hour at not more than 80° C. After a further 2 hours at 80° C., the NCO content is <0.1 wt %. The viscosity at 80° C. is 17.9 Pas. The viscosity at a 30% dilution in HDDA is 0.09 Pas.

### B2) Comparative Example to B1, no 1:1 Monoadduct, Not Inventive

35.0 g of IPDI are introduced with 0.2 g of BHT and 0.2 g of DBTL, and heated to 50° C. 38.3 g of CAPA 4101 and 18.4 g of HEA are added dropwise over the course of 1 hour at not more than 80° C. After a further 2 hours at 80° C., the NCO content is <0.1% by weight. The viscosity at 80° C. is 47.5 Pas. The viscosity at 30% dilution in HDDA is 0.20 Pas.

### C1) Preparation of Inventive Urethane Acrylates Based on Trifunctional Alcohols

3.7 g of trimethylolpropane (Aldrich) are introduced in 35 ml of acetone with 0.1 g of BHT and 0.1 g of DBTL, and heated to 50° C. 29.1 g of low-monomer-content IPDI-HEA from Experiment 1 are added dropwise under reflux over the course of 1 hour. After a further 8 hours at reflux, the NCO content is <0.1 wt %.

The solvent is stripped off fully under reduced pressure. The viscosity at 100° C. is 57 Pas. The viscosity at 30% dilution in HDDA is 0.07 Pas.

### C2) Comparative Example to C1, no 1:1 Monoadduct, Not Inventive

3.7 g of trimethylolpropane (Aldrich) are introduced in 35 ml of acetone with 0.1 g of BHT and 0.1 g of DBTL, and heated to 50° C. 19.1 g of IPDI are added dropwise under reflux over the course of 1 hour. Then 10.0 g of HEA are added dropwise at the same temperature. After a further 8 hours at reflux, the NCO content is <0.1% by weight. The solvent is stripped off completely under reduced pressure. The viscosity at 100° C. is 317 Pas. The viscosity at 30% dilution in HDDA is 0.16 Pas.

### D) Comparative Examples of Urethane Acrylates Based on Difunctional Alcohols, Not Inventive

After it was shown that the viscosity of the urethane acrylates based on the trifunctional polyols is significantly lower when using low-monomer-content IPDI-HEA, it is now shown that the viscosity in the case of difunctional polyols is about the same.

D1) Comparative product comprising low-monomer-content IPDI HEA and Oxyester T1136 48.5 g of low-monomer-content IPDI-HEA from Experiment 1 are introduced with 0.2 g of BHT and 0.2 g of DBTL, and heated to 50° C. 71.4 g of Oxyester T1136 are added dropwise over the course of 1 hour at not more than 80° C. After a further 2 hours at 80° C., the NCO content is <0.1%. The viscosity at 80° C. is 3.3 Pas. The viscosity at 30% dilution in HDDA is 0.08 Pas.

### D2) Comparative Product Comprising IPDI HEA Mixture and Oxyester T1136

32.8 g of IPDI are introduced with 0.2 g of BHT and 0.2 g of DBTL, and heated to 50° C. 74.6 g of Oxyester T1136 and 17.2 g of HEA are added dropwise over the course of 1 hour at not more than 80° C. After a further 2 hours at 80° C., the NCO content is <0.1%. The viscosity at 80° C. is 3.3 Pas. The viscosity at 30% dilution in HDDA is 0.08 Pas.

As demonstrated experimentally, low-monomer-content IPDI-HEA adduct in urethane acrylates always leads to significantly lower viscosities than the conventional mixture of IPDI and HEA when the OH functionality of the resin component is at least 3.

1. A urethane (meth)acrylate comprising the reaction product of:
A) low-monomer-content 1:1 monoadduct(s) of
a1) at least one diisocyanate, and
a2) at least one compound which contains both an alcohol group and an activated double bond, wherein the monoadduct(s) have having a free diisocyanate content of less than 5 wt %, with
B) at least one resin component having at least three OH groups per molecule;
wherein for each OH group in component B) there are 0.2 to 1.1 NCO equivalents of component A).

2. A urethane (meth)acrylate according to claim 1, wherein diisocyanate a) is at least one selected from the group consisting of 1,2-ethylene diisocyanate, 1,4-tetramethylene diisocyanate, 1,6-hexamethylene diisocyanate, 2,2,4-trimethyl-1,6-hexamethylene diisocyanate, 1,9-diisocyanato-5-methylnonane, 1,8-diisocyanato-2,4-dimethyloctane, 1,12-dodecane diisocyanate, ω,ω′-diisocyanatodipropyl ether, cyclobutene 1,3-diisocyanate, cyclohexane 1,3-diisocyanate, cyclohexane 1,4-diisocyanate, 3-isocyanatomethyl-3,5,5-trimethylcyclohexyl isocyanate (isophoronc diisocyanate, IPDI), 1,4-diisocyanatomethyl-2,3,5,6-tetramethylcyclohexane, decahydro-8-methyl-(1,4-methanonaphthalen-2,5-ylenedimethylene diisocyanate, decahydro-8-methyl-(1,4-methanonaphthalen-3,5-ylenedimethylene diisocyanate, hexahydro-4,7-methanoindan-1,5-ylenedimethylene diisocyanate, hexahydro-4,7-methanoindan-2,5-ylenedimethylene diisocyanate, hexahydro-4,7-methanoindan-1,6-ylenedimethylene diisocyanate, hexahydro-4,7-methanoindan-2,5-ylenedimethylene diisocyanate, hexahydro-4,7-methanoindan-1,5-ylene diisocyanate, hexahydro-4,7-methanoindan-2,5-ylene diisocyanate, hexahydro-4,7-methanoindan-1,6-ylene diisocyanate, hexahydro-4,7-methanoindan-2,6-ylene diisocyanate, 2,4-hexahydrotolylene diisocyanate, 2,6-hexahydrotolylene diisocyanate, 4,4′-methylenedicyclohexyl diisocyanate, 2,2′-methylenedicyclohexyl diisocyanate, 2,4-methylenedicyclohexyl diisocyanate or else mixtures of these isomers, 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetramethylbenzene, 2-methyl-1,5-diisocyanatopentane, 2-ethyl-1,4-diisocyanatobutane, 1,10-diisocyanatodecane, 1,5-diisocyanatohexane, 1,3-diisocyanatomethylcyclohexane, 1,4-diisocyanatomethylcyclohexane, 2,5-bis(isocyanatomethyl)bicyclo[2.2.1]heptane, 2,6-bis(isocyanatomethyl)bicyclo[2.2.1]heptane, and mixtures thereof.

3. A urethane (meth)acrylate according to claim 1, wherein said diisocyanate a1) is at least one selected from the group consisting of IPDI, HDI, TMDI, and H₁₂MDI as pure H₁₂MDI isomers or as their isomer mixtures, and mixtures thereof.

4. A urethane (meth)acrylate according to claim 1, wherein compound a2) is at least one olefinic compound that carries at least one methacrylate or acrylate function or vinyl ether group and carries precisely one hydroxyl group.

5. A urethane (meth)acrylate according to claim 1, wherein compound a2) is at least one selected from the group consisting of hydroxyethyl acrylate, hydroxypropyl acrylate, hydroxybutyl acrylate and hydroxyethyl methacrylate, hydroxypropyl methacrylate, hydroxybutyl methacrylate, glycerol diacrylate, pentaerythritol triacrylate, trimethylolpropane diacrylate, glycerol dimethacrylate, pentaerythritol trimethacrylate and trimethylolpropane dimethacrylate, hydroxyethyl vinyl ether, hydroxypropyl vinyl ether, hydroxybutyl vinyl ether, hydroxypentyl vinyl ether, hydroxyhexyl vinyl ether, and mixtures thereof.

6. A urethane (meth)acrylate according to claim 1, wherein said resin component B) comprises at least one polyester, polycaprolactone, polyether, poly(meth)acrylate, polycarbonate, polyurethane, monomeric polyol or a mixture thereof, having an OH functionality≧3 and an OH number of 5 to 2,000 mg KOH/gram and an average molar mass of 92 to 30,000 g/mol.

7. A urethane (meth)acrylate according to claim 1 wherein said resin component B) comprises at least one polyol having an OH number of 30 to 200 mg KOH/gram and an average molar mass of 840 to 5,600 g/mol are used.

8. A urethane (meth)acrylate according to claim 1, wherein said resin component B) comprises at least one polyester or polyether, or both.

9. A process for preparing a urethane (meth)acrylate according to claim 1, comprising reacting components A) and B), wherein
A) is at least one low-monomer-content 1:1 monoadduct of
a1) at least one diisocyanate and
a2) at least one compound which contains both an alcohol group and an activated double bond, having a free diisocyanate content of less than 5 wt %, and wherein with
B) is at least one resin component having at least three OH groups per molecule;
wherein for each OH group in component B) there are 0.2 to 1.1 NCO equivalents of component A).

10. A process for preparing a urethane (meth)acrylate. according to claim 9, wherein said catalyst is at least one selected from the group consisting of dibutyltin dilaurate, dibutyltin dineodecanoate, zinc octoate, bismuth neodecanoate, triethylamine and diazabicyclooctane.

11. A method for radiation-curing comprising irradiating a composition comprising the urethane acrylate according to claim 1.

12. A urethane (meth)acrylate prepared by:
reacting a1) at least one diisocyanate with a2) at least one compound which contains both an alcohol group and an activated double bond, to form a composition comprising A) a low-monomer-content 1:1 monoadduct(s) having a free diisocyanate content of less than 5 wt %, and
reacting said composition comprising A) said low-monomer-content 1:1 monoadduct(s) with B) at least one resin component having at least three OH groups per molecule, wherein in a reaction mixture of A) and B) for each OH group in B) there are 0.2 to 1.1 NCO equivalents of A);
wherein said urethane has a reduced viscosity compared to an otherwise identical urethane (meth)acrylate produced by reacting A) with a resin component having fewer than three OH groups per molecule; and/or produced without A) 1:1 monoadducts.

13. The urethane (meth)acrylate according to claim 12, wherein said composition comprising A) said monoadduct(s) has a free diisocyanate content of less than 0.5 wt %.

14. The urethane (meth)acrylate according to claim 12, wherein A) said monoadduct(s) have a free NCO content of 10.4-16.4 wt %.

15. The urethane (meth)acrylate according to claim 12, wherein B) is selected to have an OH number of 5 to 2,000 mg KOH/gram and an average molar mass of 92 to 30,000 g/mol.

16. The urethane (meth)acrylate according to claim 12, wherein B) is selected to have an OH number of 30 to 200 mg KOH/gram and an average molar mass of 840 to 5,600 g/mol.

17. A coating, adhesive or sealant comprising the urethane (meth)acrylate of claim 12.

18. A method for making a urethane (meth)acylate that has a low viscosity comprising:
reacting a1) at least one diisocyanate with a2) at least one compound which contains both an alcohol group and an activated double bond, to form a composition comprising A) a low-monomer-content 1:1 monoadduct(s) having a free diisocyanate content of less than 5 wt %, and
reacting said composition comprising A) said low-monomer-content 1:1 monoadduct(s) with B) at least one resin component having at least three OH groups per molecule, wherein in a reaction mixture of A) and B) for each OH group in B) there are 0.2 to 1.1 NCO equivalents of A);
wherein said urethane has a lower viscosity compared to an otherwise identical urethane (meth)acrylate produced by reacting A) with a resin component having fewer than three OH groups per molecule; and/or produced without A) 1:1 monoadducts.
